(19) United States
(12) Patent Application Publication
(10) Pub. No.: US 2020/0382214 A1
(43) Pub. Date: Dec. 3, 2020

(54) ACTIVE OPTICAL CABLE

(71) Applicant: FUJIKURA LTD., Tokyo (JP)

(72) Inventor: Teijiro Ori, Chiba (JP)

(73) Assignee: FUJIKURA LTD., Tokyo (JP)

(21) Appl. No.: 16/636,796

(22) PCT Filed: May 10, 2018
(86) PCT No.: PCT/JP2018/018166

§ 371 Date: Feb. 5, 2020

(30) Foreign Application Priority Data
Aug. 15, 2017 (JP) 2017-156711

(51) Int. Cl. H04B 10/25; G02B 6/42; G02B 6/293; H04B 10/50; H04J 14/04; H04B 10/2587

(52) U.S. Cl. CPC H04B 10/25891; G02B 6/4246; G02B 6/29361; H04B 10/61; H04J 14/04; H04B 10/2587; H04B 10/502

(57) ABSTRACT

An active optical cable that allows bidirectional communication includes: a plurality of optical fibers; and a first optical module and a second optical module that are coupled via the plurality of optical fibers. The first optical module includes: at least one first light emitting element that emits laser light and a second light emitting element that also emits laser light; and a first modulator that modulates first laser light and converts the first laser light into first signal light. The first laser light is part of the laser light emitted by the at least one first light emitting element. The second optical module includes a second modulator that modulates second laser light and converts the second laser light into second signal light.

### TECHNICAL FIELD

The present invention relates to an active optical cable.

### BACKGROUND

An active optical cable (AOC), which is a transmission medium that is used as an alternative to a metal cable, has attracted attention. As illustrated in FIG. 1 of Patent Literature 1, an AOC that allows bidirectional communication with use of an optical signal includes: a cable that contains an optical fiber; and a first optical module and a second optical module that are provided at respective both ends of the cable. The first optical module and the second optical module each include (i) a transmitter module including a light emitting element and (ii) a receiver module including a light receiving element. Examples of the light emitting element include a vertical cavity surface emitting laser (VCSEL) and an edge emitting laser. Examples of the light receiving element include a PIN-PD and an APD. In the following description, a surface emitting laser and an edge emitting laser are collectively referred to as a laser diode (LD), and a PIN-PD and an APD are collectively referred to as a photo diode (PD).

The transmitter module of the first optical module is coupled to the receiver module of the second optical module via an optical fiber. The transmitter module converts an electric signal into an optical signal. The optical signal, into which the electric signal has been converted by the transmitter module, is transmitted via the optical fiber. The receiver module converts, into an electric signal, the optical signal, which has been transmitted via the optical fiber. The transmitter module of the first optical module, the receiver module of the second optical module, and the optical fiber thus constitute a first transmitter-receiver module.

The transmitter module of the second optical module is coupled to the receiver module of the first optical module via an optical fiber. The transmitter module of the second optical module, the receiver module of the first optical module, and the optical fiber constitute a second transmitter-receiver module as in the case of the first transmitter-receiver module.

Since the first transmitter-receiver module and the second transmitter-receiver module, each of which is configured as described earlier, are provided in directions opposite to each other, the AOC achieves bidirectional optical communication between a device (first device) to which the first optical module is connected and a device (second device) to which the second optical module is connected.

### PATENT LITERATURE

[Patent Literature 1]

Japanese Patent Application Publication Tokukai No. 2015-8380

According to a conventional AOC, an optical signal that is transmitted from a second optical module to a first optical module is generated by modulating light that is emitted from a light emitting element that is provided in the second optical module. Thus, in a case where insufficient electric power is supplied from a second external device to the second optical module, the light emitting element that is provided in the second optical module unstably emits light. This makes it impossible or unstable to transmit the optical signal from the second optical module to the first optical module.

### SUMMARY

One or more embodiments of the present invention provide an AOC that allows stable bidirectional communication also in a case where insufficient electric power is supplied from one of two devices to which the AOC is connected.

One or more embodiments of the present invention provide an active optical cable that allows bidirectional communication, the active optical cable including: a plurality of optical fibers; and a first optical module and a second optical module that are coupled via the plurality of optical fibers. According to the present active optical cable, the first optical module includes (i) at least one light emitting element (i.e., at least one first light emitting element) that emits laser light and (ii) a first modulator that modulates first laser light so as to convert the first laser light into first signal light, the first laser light being included in the laser light, and the second optical module includes a second modulator that modulates second laser light so as to convert the second laser light into second signal light, the second laser light being included in (a) the laser light or (b) laser light that is emitted by a second light emitting element (i.e., a light emitting element that is different from the at least one light emitting element) included in the first optical module.

One or more embodiments of the present invention make it possible to achieve stable bidirectional communication also in a case where electric power that is supplied from one of two devices that are connected via an AOC is insufficient to drive a light emitting element.

### BRIEF DESCRIPTION OF THE DRAWINGS

FIG. 1 is a block diagram illustrating a configuration of an active optical cable according to one or more embodiments of the present invention.

FIG. 2 is a block diagram illustrating a configuration of an active optical cable according to one or more embodiments of the present invention.

FIG. 3 is a block diagram illustrating a configuration of an active optical cable according to one or more embodiments of the present invention.

FIG. 4 is a block diagram illustrating a configuration of an active optical cable according to one or more embodiments of the present invention.

FIG. 5 is a block diagram illustrating a configuration of an active optical cable according to one or more embodiments of the present invention.

FIG. 6 is a block diagram illustrating a configuration of an active optical cable according to one or more embodiments of the present invention.

### DETAILED DESCRIPTION

(Overview of Active Optical Cable)

An active optical cable (AOC) including two optical modules (a first optical module and a second optical module) that are optically coupled via an optical fiber is a cable that achieves bidirectional communication between two devices (the first optical module and the second optical module) with use of an optical signal. The AOC allows a large amount of data to be transmitted at a high speed. Thus, the AOC can replace a conventionally used metal cable.

Furthermore, an optical signal that is transmitted via an optical fiber is much smaller in transmission loss than an electric signal that is transmitted via a metal cable. This allows the AOC to achieve bidirectional communication also between two devices that are at a long distance (e.g., not shorter than 10 m and not longer than 1000 m). It is impossible for a connection between the two devices via a metal cable to achieve bidirectional communication in such a long distance.

Examples of the AOC that can be used include an InfiniBand (Registered Trademark) type cable, a cable conforming to a camera link standard, a cable conforming to a High-definition Digital Media Interface (HDMI, Registered Trademark) standard, and a cable conforming to a Universal Serial Bus (USB) interface standard.

Meanwhile, it is assumed that, for example, a personal computer and a camera, or a personal computer and an optical drive (e.g., a Blu-ray (Registered Trademark) disk drive) are connected via (i) an AOC conforming to a camera link standard and (ii) an AOC conforming to a USB interface standard. In this case, the personal computer may be sufficiently capable of supplying electric power, but the camera or the optical drive may be insufficiently capable of supplying electric power.

An AOC in accordance with one or more embodiments described below achieves stable bidirectional communication also in a case where electric power that is supplied from one of two external devices (a first external device (not illustrated) and a second external device (not illustrated)), to which the AOC is connected, is thus insufficient to drive an LD. In the following description, an external device that is more capable of supplying electric power is assumed to be the first external device, and an external device that is less capable of supplying electric power is assumed to be the second external device.

(Configuration of AOC 1)

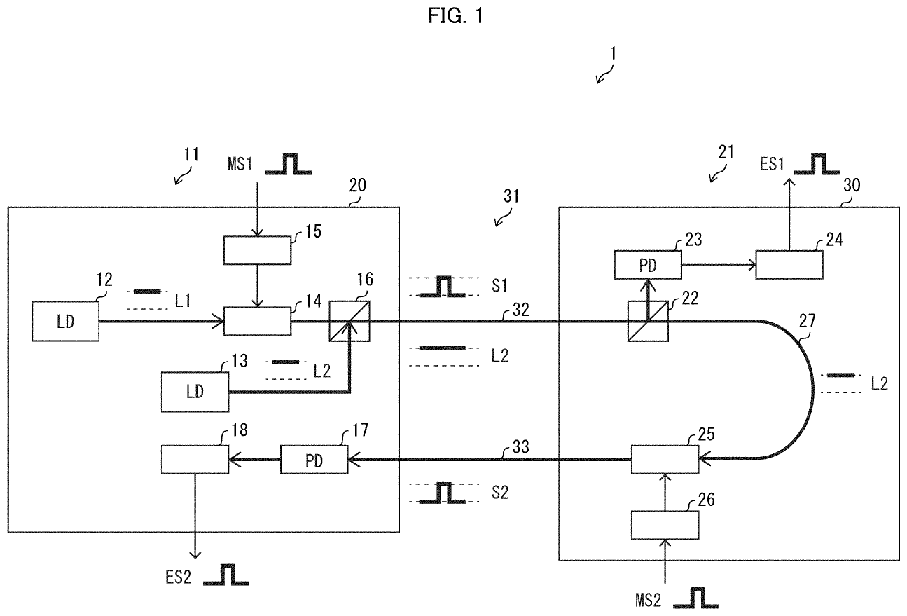

First, a configuration of an active optical cable (AOC) 1 in accordance with one or more embodiments of the present invention is described below with reference to FIG. 1. FIG. 1 is a block diagram illustrating a configuration of the AOC 1.

As illustrated in FIG. 1, the AOC 1 is an AOC that allows bidirectional communication and includes an optical module 11, which is the first optical module, an optical module 21, which is the second optical module, and a cable 31. The cable 31 includes optical fibers 32 and 33, which are a plurality of optical fibers. According to one or more embodiments, a single mode fiber is employed as each of the optical fibers 32 and 33. The optical module 11 and the optical module 21 are optically coupled via the optical fibers 32 and 33.

The optical module 11 that is connectable to the first external device includes a laser diode (LD) 12, which is a first light emitting element, an LD 13, which is a second light emitting element, a modulator 14, which is a first modulator, a driver 15, a dichroic mirror 16, a photodiode (PD) 17, an amplifier 18, and a connector 20. The connector 20, which is a housing that houses the optical module 11, includes the LD 12, the LD 13, the modulator 14, the driver 15, the dichroic mirror 16, the PD 17, and the amplifier 18.

The LD 12 and the LD 13 emit respective beams of laser light (continuously oscillating light) which beams have respective different wavelengths. According to one or more embodiments, the LD 12 emits laser light L1 that has a wavelength of 1310 nm, and the LD 13 emits laser light L2 that has a wavelength of 1550 nm. The laser light L2 that has been emitted by the LD 13 is supplied to the dichroic mirror 16.

The laser light L1 that has been emitted by the LD 12 is supplied to the modulator 14. The driver 15 drives the modulator 14 in accordance with an electric signal MS1 that has been obtained from the first external device (not illustrated). The modulator 14 generates signal light S1 by modulating, in accordance with the electric signal MS1, the laser light L1 that has been emitted by the LD 12. The signal light S1 that has been generated by the modulator 14 is supplied to the dichroic mirror 16.

The dichroic mirror 16, which is a wavelength multiplexer, generates combined light S1+L2 by wavelength-combining (wavelength-multiplexing) (i) the signal light S1 that has been modulated by the modulator 14 and (ii) the laser light L2 that has been emitted by the LD 13. Specifically, the dichroic mirror 16 generates the combined light S1+L2 by (i) transmitting therethrough the signal light S1 that has been modulated by the modulator 14 and (ii) reflecting the laser light L2 that has been emitted by the LD 13. The combined light S1+L2 that has been generated by the dichroic mirror 16 is transmitted to the optical module 21 via the optical fiber 32.

The PD 17 converts, into an electric signal ES2, signal light S2 that has been received from the optical module 21 via the optical fiber 33. The electric signal ES2 that has been obtained by the PD 17 is supplied to the amplifier 18. The amplifier 18, which is constituted by, for example, a transimpedance amplifier and a limiting amplifier, amplifies the electric signal ES2 that has been obtained by the PD 17. The electric signal ES2 that has been amplified by the amplifier 18 is supplied to the first external device (not illustrated).

In contrast, the optical module 21 that is connectable to the second external device includes a dichroic mirror 22, a PD 23, an amplifier 24, a modulator 25, which is a second modulator, a driver 26, an optical fiber 27, and a connector 30. The connector 30, which is a housing that houses the optical module 21, includes the dichroic mirror 22, the PD 23, the amplifier 24, the modulator 25, which is the second modulator, the driver 26, and the optical fiber 27.

The dichroic mirror 22, which is a wavelength demultiplexer, obtains the signal light S1 and the laser light L2 by wavelength-resolving the combined light S1+L2 that has been received from the optical module 11 via the optical fiber 32. Specifically, the dichroic mirror 22 obtains the signal light S1 and the laser light L2 by reflecting the signal light S1 and transmitting therethrough the laser light L2. As described earlier, in the AOC 1, a wavelength multiplexing method is employed as a method by which to multiplex (or demultiplex) the signal light S1 (hereinafter may also be referred to as “first signal light S1”) and the laser light L2 (hereinafter may also be referred to as “second laser light L2”).

The signal light S1 that has been obtained by the dichroic mirror 22 is supplied to the PD 23. The PD 23 converts the signal light S1 into an electric signal ES1. The electric signal ES1 that has been obtained by the PD 23 is supplied to the amplifier 24. The amplifier 24, which is constituted by, for example, a transimpedance amplifier and a limiting amplifier, amplifies the electric signal ES1 that has been obtained by the PD 23. The electric signal ES1 that has been amplified by the amplifier 24 is supplied to the second external device (not illustrated).

The laser light L2 that has been obtained by the dichroic mirror 22 is supplied to the modulator 25 via the optical fiber 27. The driver 26 drives the modulator 25 in accordance with an electric signal MS2 that has been obtained from the second external device (not illustrated). The modulator 25 generates the signal light S2 by modulating, in accordance with the electric signal MS2, the laser light L2 that has been obtained by the dichroic mirror 22. The signal light S2 that has been generated by the modulator 25 is transmitted to the PD 17 of the optical module 11 via the optical fiber 33. Thereafter, the signal light S2 is converted into the electric signal ES2 by the PD 17 (described earlier). Then, the electric signal ES2 is amplified by the amplifier 18, and the electric signal ES2 that has been amplified by the amplifier 18 is supplied to the first external device (not illustrated).

As described earlier, according to the AOC 1, the LD 13 that emits the second laser light L2 is included not in the second optical module 21 but in the first optical module 11. Thus, according to the AOC 1, it is unnecessary to supply, to the second optical module 21, electric power by which to generate the second laser light L2. This makes it possible to achieve the AOC 1 that allows stable bidirectional communication also in a case where electric power that is insufficient to generate the second laser light L2 is supplied from the second external device.

According to the AOC 1, a light source for emitting the second laser light L2 is constituted only by the LD 13. Note, however, that the AOC 1 in accordance with one or more embodiments of the present invention can be configured such that the light source for emitting the second laser light L2 is constituted by a plurality of LDs. In this case, at least one of the plurality of LDs for emitting the second laser light L2 is provided in the optical module 11. The configuration makes it unnecessary for at least one of the plurality of LDs for emitting the second laser light L2 to be provided in the optical module 21. Thus, the optical module 21 does not need to have any space in which to provide at least one LD. Consequently, the AOC 1 allows the optical module 21 to have a smaller size.

Furthermore, since the at least one LD (described earlier) is dispensable, the AOC 1 allows a reduction in amount of heat that may be generated by the second optical module 21. In a case where heat that may be generated by the second optical module 21 is reduced to a sufficiently large degree, a heat dissipating component (e.g., a TEC, which is an example of a cooling mechanism that is constituted by, for example, a heat dissipating fin and a Peltier element) for dissipating heat that may be emitted by an LD that emits the second laser light L2 is dispensable. This dispenses with not only the space in which to provide the at least one LD (described earlier) but also a space in which to provide the heat dissipating component. Thus, the configuration further allows the optical module 21 to have a smaller size. As described earlier, the AOC 1 allows a reduction in amount of heat that may be generated by the second optical module 21. In a case where the heat dissipating component is omitted, the AOC 1 further allows the second optical module 21 to have a smaller size.

Note here that the LD 13, which emits the second laser light L2 in the AOC 1, is included, as the at least one LD (described earlier), in the optical module 11 but not in the optical module 21 (see FIG. 1). This makes it unnecessary for the second external device that is connected with the second optical module 21 to supply electric power by which to drive the LD that emits the second laser light L2. Furthermore, in a case where the heat dissipating component is omitted, it is also unnecessary to supply, to the second optical module 21, electric power by which to cause the LD that emits the second laser light L2 to dissipate heat. This allows the AOC 1 to be used in a case where the second external device that is connected with the second optical module 21 is less capable of supplying electric power.

Note that the AOC 1 in accordance with one or more embodiments of the present invention can alternatively be configured such that the light source for emitting the second laser light L2 is constituted by the plurality of LDs as described earlier and the plurality of LDs are partially included in the optical module 21. Also in this case, at least one of the plurality of LDs for emitting the second laser light L2 is provided in the optical module 11. Thus, as compared with a configuration in which all the plurality of LDs (described earlier) are included in the optical module 21, the configuration in which the plurality of LDs are partially included in the optical module 21 allows the second external device to supply reduced electric power so as to drive the LD that emits the second laser light L2.

According to the AOC 1, respective wavelengths of the first laser light L1 and the second laser light L2 are not limited to the example (described earlier). That is, the first laser light L1 can have a wavelength of 1310 nm or a wavelength different from 1310 nm, and the second laser light L2 can have a wavelength of 1550 nm or a wavelength different from 1550 nm. Note, however, that, as compared with the first laser light L1 that has a wavelength of 1310 nm, the second laser light L2 that has a wavelength of 1550 nm is less likely to suffer a transmission loss while being transmitted through the optical fiber 32. Therefore, a configuration of one or more embodiments in which configuration the second laser light L2 that is less likely to suffer a transmission loss is moved back and forth between the first optical module 11 and the second optical module 21 is more advantageous than a configuration in which the first laser light L1 that is more likely to suffer a transmission loss is moved back and forth between the first optical module 11 and the second optical module 21.

In the AOC 1, a single LD 13 is employed as at least one light emitting element for emitting the second laser light L2. Note, however, that the AOC 1 in accordance with one or more embodiments of the present invention can alternatively be configured such that the at least one light emitting element for emitting the second laser light L2 comprises a plurality of light emitting elements for emitting the second laser light L2. In this case, at least one of the plurality of light emitting elements for emitting the second laser light L2 can be included in the first optical module 11. The configuration allows an external device that is connected with the second optical module 21 to supply reduced electric power to the second optical module 21. This allows the AOC 1 that is connected to the two external devices to achieve stable bidirectional communication also in a case where electric power that is insufficient to drive all the light emitting elements is supplied from the second external device. In a case where the at least one light emitting element for emitting the second laser light L2 comprises a plurality of light emitting elements for emitting the second laser light L2, all the light emitting elements for emitting the second laser light L2 may be included in the first optical module 11. That is, none of the light emitting elements for emitting the second laser light L2 may be included in the second optical module 21. The configuration makes it unnecessary for the external device with which the second optical module 21 is connected to supply, to the second optical module 21, electric power by which to drive the light emitting elements. This allows the AOC 1 that is connected to the two external devices to achieve more stable bidirectional communication also in a case where electric power that is insufficient to drive the light emitting elements is supplied from the second external device.

Furthermore, in the AOC 1, the LD 12 and the LD 13, which are separate LDs, are employed to emit the first laser light L1 and the second laser light L2, respectively. Note, however, that a single light emitting element that emits laser light including the first laser light L1 and the second laser light L2 that have respective different wavelengths can alternatively be employed instead of at least the LD 12 and the LD 13. In this case, the first laser light L1 and the second laser light L2 can be wavelength-demultiplexed, with use of a dichroic mirror that is configured as in the case of the dichroic mirror 22, from the laser light including the first laser light L1 and the second laser light L2. Examples of such a light emitting element include a semiconductor DFB laser and a semiconductor Fabry-Perot laser.

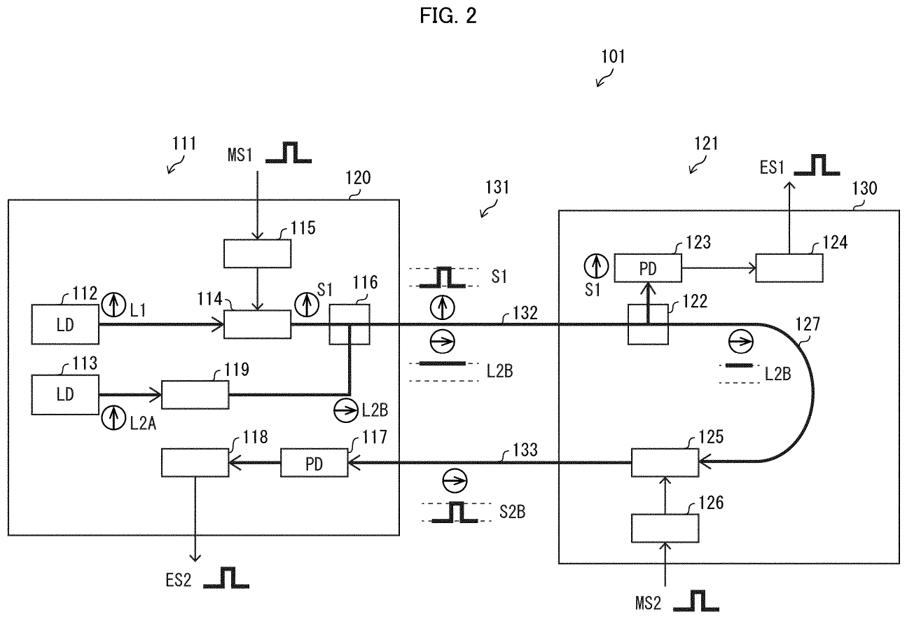

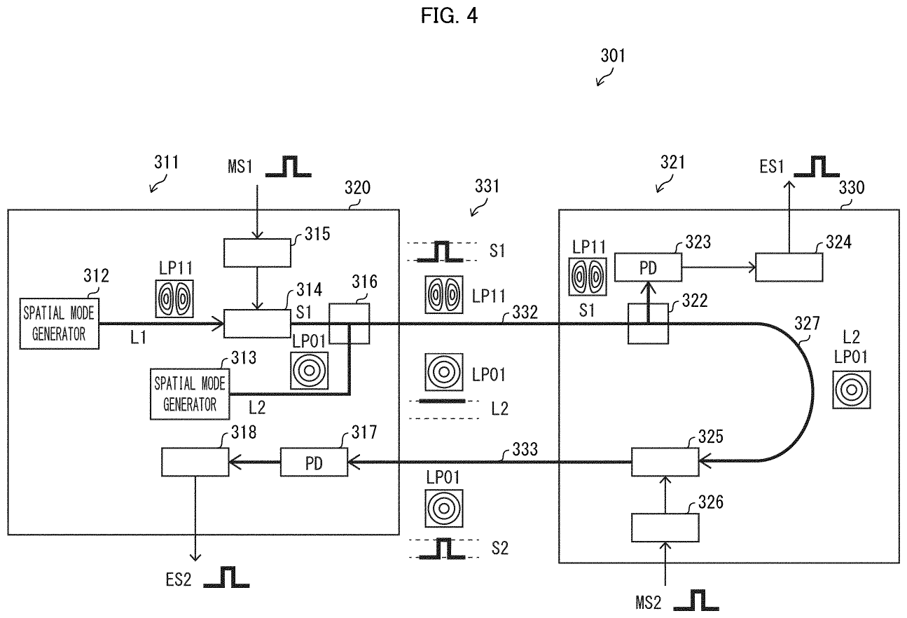

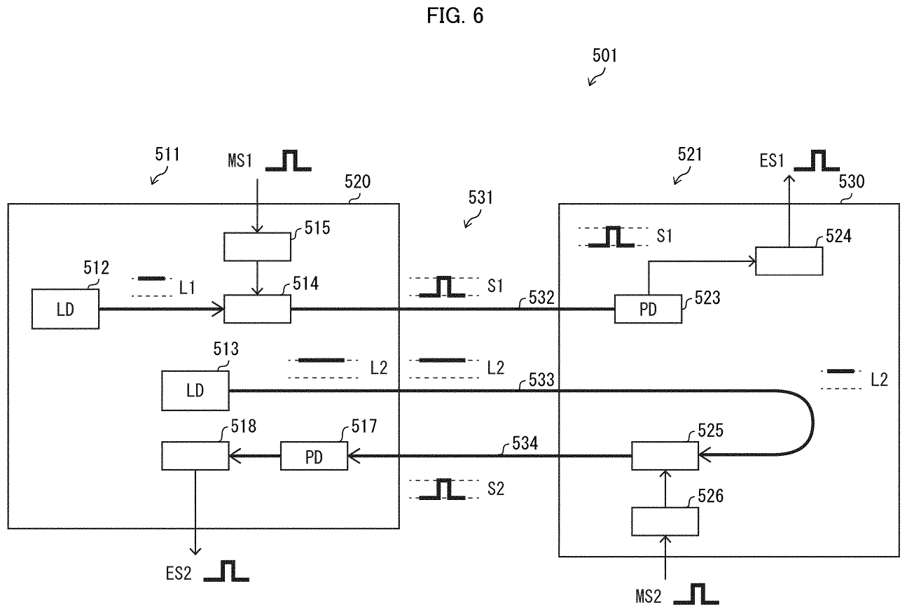

Moreover, in the AOC 1, the LD 12 and the modulator 14, which are separate optical elements, are employed as a light emitting element and a first modulator, respectively. Note, however, that in the AOC 1, a modulation light source obtained by integrating a function of the LD 12 and a function of the modulator 14 into a single optical element can alternatively be employed as the light emitting element and the first modulator. Note that the modulation light source obtained by integrating the function of the light emitting element and the function of the first modulator is applicable not only to the AOC 1 but also to an AOC 101 (described later, see FIG. 2), an AOC 301 (described later, see FIG. 4), and an AOC 501 (described later, see FIG. 6).

Next, an AOC in accordance with one or more embodiments of the present invention is described below.

(Configuration of AOC 101)

First, a configuration of the AOC 101 in accordance with one or more embodiments of the present invention is described below with reference to FIG. 2. FIG. 2 is a block diagram illustrating the configuration of the AOC 101.

As illustrated in FIG. 2, the AOC 101 is an AOC that allows bidirectional communication and includes an optical module 111, which is a first optical module, an optical module 121, which is a second optical module, and a cable 131. The cable 131 includes optical fibers 132 and 133, which are a plurality of optical fibers. According to one or more embodiments, a polarization maintaining fiber (e.g., a PANDA fiber) is employed as the optical fiber 132 and employs a single mode fiber as the optical fiber 133. The optical module 111 and the optical module 121 are optically coupled via the optical fibers 132 and 133.

The optical module 111 that is connectable to a first external device (not illustrated) includes an LD 112, which is a first light emitting element, an LD 113, which is a second light emitting element, a modulator 114, which is a first modulator, a driver 115, a polarization beam combiner 116, a PD 117, an amplifier 118, a polarization rotator 119, and a connector 120. The connector 120, which is a housing that houses the optical module 111, includes the LD 112, the LD 113, the modulator 114, the driver 115, the polarization beam combiner 116, the PD 117, the amplifier 118, and the polarization rotator 119.

The LD 112 and the LD 113 emit respective beams of laser light (continuously oscillating light) which beams are equal in wavelength. According to one or more embodiments, the LD 112 emits laser light L1 that has a wavelength of 1550 nm, and the LD 113 emits laser light L2A that has a wavelength of 1550 nm. The laser light L2A that has been emitted by the LD 113 is supplied to the polarization rotator 119. By rotating 90° a direction in which the laser light L2A is polarized, the polarization rotator 119 generates laser light L2B that is polarized in a direction orthogonal to the laser light L1. The laser light L2B that has been generated by the polarization rotator 119 is supplied to the polarization beam combiner 116.

The laser light L1 that has been emitted by the LD 112 is supplied to the modulator 114. The driver 115 drives the modulator 114 in accordance with an electric signal MS1 that has been obtained from the first external device (not illustrated). The modulator 114 generates signal light S1 by modulating, in accordance with the electric signal MS1, the laser light L1 that has been emitted by the LD 112. The signal light S1 that has been generated by the modulator 114 is supplied to the polarization beam combiner 116.

The polarization beam combiner 116 generates combined light S1+L2B by polarization-combining (polarization-multiplexing) (i) the signal light S1 that has been modulated by the modulator 114 and (ii) the laser light L2B that has been generated by the polarization rotator 119. Specifically, the polarization beam combiner 116 generates the combined light S1+L2B by (i) transmitting therethrough the signal light S1 that has been modulated by the modulator 114 and (ii) reflecting the laser light L2B that has been generated by the polarization rotator 119. The combined light S1+L2B that has been generated by the polarization beam combiner 116 is transmitted to the optical module 121 via the optical fiber 132.

The PD 117 converts, into an electric signal ES2, signal light S2B that has been received from the optical module 121 via the optical fiber 133. The electric signal ES2 that has been obtained by the PD 117 is supplied to the amplifier 118. The amplifier 118, which is constituted by, for example, a transimpedance amplifier and a limiting amplifier, amplifies the electric signal ES2 that has been obtained by the PD 117. The electric signal ES2 that has been amplified by the amplifier 118 is supplied to the first external device (not illustrated).

In contrast, the optical module 121 that is connectable to a second external device (not illustrated) includes a polarization beam splitter 122, a PD 123, an amplifier 124, a modulator 125, which is a second modulator, a driver 126, an optical fiber 127, and a connector 130. The connector 130, which is a housing that houses the optical module 121, includes the polarization beam splitter 122, the PD 123, the amplifier 124, the modulator 125, the driver 126, and the optical fiber 127.

The polarization beam splitter 122 obtains the signal light S1 and the laser light L2B by polarization-separating the combined light S1+L2B that has been received from the optical module 111 via the optical fiber 132. Specifically, the polarization beam splitter 122 obtains the signal light S1 and the laser light L2B by reflecting the signal light S1 and transmitting therethrough the laser light L2B. As described earlier, in the AOC 101, a polarization multiplexing method is employed as a method by which to multiplex (or demultiplex) the signal light S1 (hereinafter may also be referred to as “first signal light S1”) and the laser light L2B (hereinafter may also be referred to as “second laser light L2B”).

The signal light S1 that has been obtained by the polarization beam splitter 122 is supplied to the PD 123. The PD 123 converts the signal light S1 into an electric signal ES1. The electric signal ES1 that has been obtained by the PD 123 is supplied to the amplifier 124. The amplifier 124, which is constituted by, for example, a transimpedance amplifier and a limiting amplifier, amplifies the electric signal ES1 that has been obtained by the PD 123. The electric signal ES1 that has been amplified by the amplifier 124 is supplied to the second external device (not illustrated).

The laser light L2B that has been obtained by the polarization beam splitter 122 is supplied to the modulator 125 via the optical fiber 127. The driver 126 drives the modulator 125 in accordance with an electric signal MS2 that has been obtained from the second external device (not illustrated). The modulator 25 generates the signal light S2B by modulating, in accordance with the electric signal MS2, the laser light L2B that has been obtained by the polarization beam splitter 122. The signal light S2B that has been generated by the modulator 25 is transmitted to the optical module 111 via the optical fiber 33.

One or more embodiments employs a configuration in which the laser light L2B is generated by rotating a direction in which the laser light L2A that has been emitted by the LD 113, which is the second light emitting element, is polarized, so that the laser light L1 and the laser light L2B are polarized in respective different directions. Note, however, that one or more embodiments of the present invention do not necessarily need to employ such a configuration. For example, one or more embodiments can alternatively employ a configuration in which a direction in which the laser light L1 that has been emitted by the LD 112, which is the first light emitting element, is polarized is rotated so that the laser light L1 and the laser light L2A are polarized in respective different directions.

One or more embodiments employs the polarization beam combiner 116 that is of a prism type and polarization-combines the signal light S1 and the laser light L2B by transmitting therethrough the signal light S1 and reflecting the laser light L2B. Note, however, that one or more embodiments of the present invention do not necessarily need to employ such a polarization beam combiner 116. For example, one or more embodiments of the present invention can alternatively employ the polarization beam combiner 116 that is of a waveguide type and polarization-combines the signal light S1 and the laser light L2B by (i) causing the signal light S1 to transition from a first waveguide, through which the signal light S1 is guided, to a second waveguide, through which the laser light L2B is guided, or (ii) causing the laser light L2B to transition from the second waveguide, through which the laser light L2B is guided, to the first waveguide, through which the signal light S1 is guided. In this case, it is possible to achieve an optical integrated circuit obtained by integrating, on a single silicon on insulator (SOI) substrate, sections of the optical module 111, in particular, the modulator 114, the polarization beam combiner 116, and the polarization rotator 119. In this case, the optical module 111 can have a smaller size than in a case where the modulator 114, the polarization beam combiner 116, and the polarization rotator 119 are combined as discrete optical components. Furthermore, the configuration makes it possible to achieve the AOC 101 that can be manufactured at lower cost.

Similarly, one or more embodiments employ the polarization beam splitter 122 that is of a prism type and polarization-separates the signal light S1 and the laser light L2B by reflecting the signal light S1 and transmitting therethrough the laser light L2B. Note, however, that one or more embodiments of the present invention do not necessarily need to employ such a polarization beam combiner 122. For example, one or more embodiments of the present invention can alternatively employ the polarization beam splitter 122 that is of a waveguide type and polarization-separates the signal light S1 and the laser light L2B by (i) causing only the signal light S1 to transition from the first waveguide, through which the signal light S1 and the laser light L2B are guided, to the second waveguide, or (ii) causing only the laser light L2B to transition from the first waveguide, through which the signal light S1 and the laser light L2B are guided, to the second waveguide. In this case, it is possible to achieve an optical integrated circuit obtained by integrating, on a single SOI substrate, sections of the optical module 121, in particular, the polarization beam splitter 122, the modulator 125, and the optical fiber 127 (an optical waveguide that functions as the optical fiber 127). In this case, the optical module 121 can have a smaller size than in a case where the polarization beam splitter 122, the modulator 125, and the optical fiber 127 (an optical waveguide that functions as the optical fiber 127) are combined as discrete optical components. Furthermore, the configuration makes it possible to achieve the AOC 101 that can be manufactured at lower cost.

Since the AOC 101 thus configured includes the polarization beam combiner 116, the polarization rotator 119, and the polarization beam splitter 122, it is possible to employ, as a method by which to multiplex the signal light S1 and the laser light L2B, a polarization multiplexing method instead of a wavelength multiplexing method. Furthermore, as compared with the AOC 101 that includes no multiplexer and no demultiplexer, the AOC 101 thus configured makes it possible to achieve the AOC 101 in which the first optical module 111 and the second optical module 121 are coupled via fewer optical fibers.

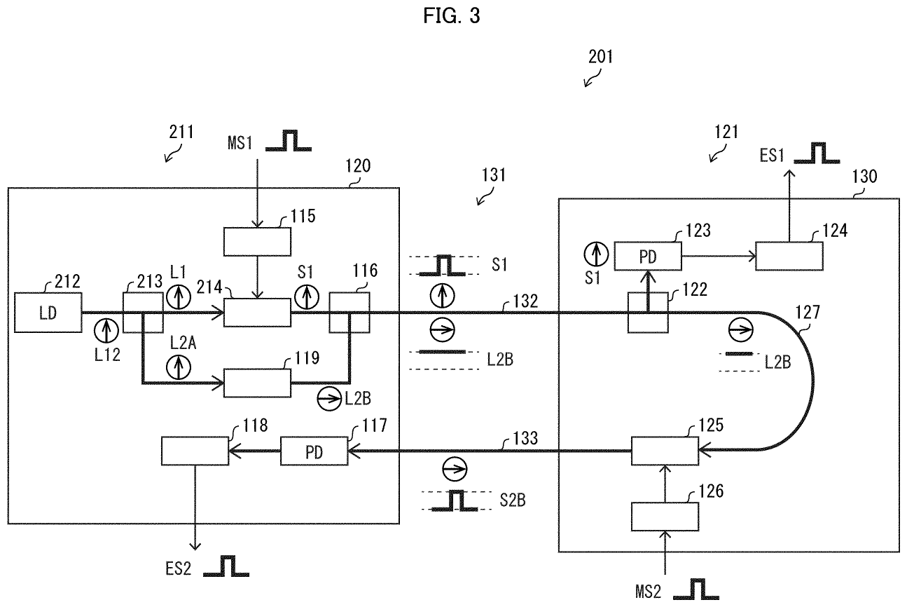

Next, the AOC 101 in accordance with one or more embodiments is described below. FIG. 3 is a block diagram illustrating a configuration of an AOC 201 in accordance with one or more embodiments.

The AOC 201 and the AOC 101 differ in (i) that the AOC 201 includes a single LD 212 instead of the LD 112 and the LD 113 and (ii) that the AOC 201 further includes a branching element 213 that causes a Y branch of laser light L12 that has been emitted by the LD 212. In the AOC 201, the branching element 213 is provided upstream of a modulator 214, a polarization beam combiner 116, and a polarization rotator 119. One of beams of laser light which beams have been branched by the branching element 213 serves as laser light L1, which is first laser light, and is supplied to the modulator 214. The other one of the beams of laser light which beams have been branched by the branching element 213 serves as laser light L2A, which is second laser light, and is supplied to the polarization rotator 119. Thus, the LD 212 emits laser light including the first laser light L1 and the second laser light L2A. That is, the LD 212 has both a function of a first light emitting element and a function of a second light emitting element. Note here that in one or more embodiments, the first laser light L1 and the second laser light L2A that are included in the laser light emitted by the LD 212 are beams of laser light which beams are identical in characteristic (e.g., wavelength). That is, the LD 212 emits the laser light in a form of a single beam of laser light in which single beam the first laser light L1 and the second laser light L2A are combined. Then, the single beam of laser light is branched into the first laser light L1 and the second laser light L2A while being propagated through the branching element 213 (see FIG. 3).

As compared with the AOC 101, the AOC 201, which allows a light emitting element of a first optical module 211 to be a single light emitting element, makes it possible to achieve the AOC 201 in which the first optical module 211 includes fewer light emitting elements.

Furthermore, according to the AOC 201, it is possible to employ a polarization maintaining fiber (e.g., a PANDA fiber) as an optical fiber 132. The polarization maintaining fiber, which is already on the market, is easily available. This makes it possible to achieve the AOC 201 that allows one or more embodiments of the present invention to be relatively easily carried out.

Note that the AOC 201 in accordance with one or more embodiments can also be configured in a form of an optical integrated circuit obtained by integrating, on a single substrate, sections of an optical module 111 and sections of an optical module 121. Thus, the configuration allows each of the optical module 111 and the optical module 121 to have a smaller size. Furthermore, the configuration makes it possible to achieve the AOC 201 that can be manufactured at lower cost.

Next, an AOC in accordance with one or more embodiments of the present invention is described below.

(Configuration of AOC 301)

First, a configuration of the AOC 301 in accordance with one or more embodiments of the present invention is described below with reference to FIG. 4. FIG. 4 is a block diagram illustrating the configuration of the AOC 301.

As illustrated in FIG. 4, the AOC 301 is an AOC that allows bidirectional communication and includes an optical module 311, which is a first optical module, an optical module 321, which is a second optical module, and a cable 331. The cable 331 includes optical fibers 332 and 333, which are a plurality of optical fibers. One or more embodiments employ, as the optical fiber 332, a several mode fiber, which is an example of a multimode fiber, and employs a single mode fiber as the optical fiber 333. The optical module 311 and the optical module 321 are optically coupled via the optical fibers 332 and 333.

The optical module 311 that is connectable to a first external device (not illustrated) includes a spatial mode generator 312, which is a first light emitting element, a spatial mode generator 313, which is a second light emitting element, a modulator 314, which is a first modulator, a driver 315, a mode combiner 316, a PD 317, an amplifier 318, and a connector 320. The connector 320, which is a housing that houses the optical module 311, includes the spatial mode generator 312, the spatial mode generator 313, the modulator 314, the driver 315, the mode combiner 316, the PD 317, and the amplifier 318.

The spatial mode generator 312 generates beams of laser light (continuously oscillating light) which beams differ in spatial mode (spatial distribution of electromagnetic waves). According to one or more embodiments, the spatial mode generator 312 generates laser light L1 in an LP 11 mode (a first mode), and the spatial mode generator 313 generates laser light L2 in an LP 01 mode (a second mode). The laser light L2 that has been generated by the spatial mode generator 313 is supplied to the mode combiner 316.

The laser light L1 that has been generated by the spatial mode generator 312 is supplied to the modulator 314. The driver 315 drives the modulator 314 in accordance with an electric signal MS1 that has been obtained from the first external device (not illustrated). The modulator 314 generates signal light S1 by modulating, in accordance with the electric signal MS1, the laser light L1 that has been generated by the spatial mode generator 312. The signal light S1 that has been generated by the modulator 314 is supplied to the mode combiner 316.

The mode combiner 316 generates combined light S1+L2 by mode-combining (mode-multiplexing) the signal light S1 that has been modulated by the modulator 314 and the laser light L2 that has been generated by the spatial mode generator 313. The combined light S1+L2 that has been combined by the mode combiner 316 is transmitted to the optical module 321 via the optical fiber 332.

The PD 317 converts, into an electric signal ES2, signal light S2 that has been received from the optical module 321 via the optical fiber 333. The electric signal ES2 that has been obtained by the PD 317 is supplied to the amplifier 318. The amplifier 318, which is constituted by, for example, a transimpedance amplifier and a limiting amplifier, amplifies the electric signal ES2 that has been obtained by the PD 317. The electric signal ES2 that has been amplified by the amplifier 318 is supplied to the first external device (not illustrated).

In contrast, the optical module 321 that is connectable to a second external device (not illustrated) includes a mode splitter 322, a PD 323, an amplifier 324, a modulator 325, which is a second modulator, a driver 326, an optical fiber 327, and a connector 330. The connector 330, which is a housing that houses the optical module 321, includes the mode splitter 322, the PD 323, the amplifier 324, the modulator 325, which is the second modulator, the driver 326, and the optical fiber 327.

The mode splitter 322 obtains the signal light S1 and the laser light L2 by mode-resolving the combined light S1+L2 that has been received from the optical module 311 via the optical fiber 332. As described earlier, in the AOC 301, a spatial mode multiplexing method is employed as a method by which to multiplex (or demultiplex) the signal light S1 (first signal light S1) and the laser light L2 (second laser light L2).

The signal light S1 that has been obtained by the mode splitter 322 is supplied to the PD 323. The PD 323 converts the signal light S1 into an electric signal ES1. The electric signal ES1 that has been obtained by the PD 323 is supplied to the amplifier 324. The amplifier 324, which is constituted by, for example, a transimpedance amplifier and a limiting amplifier, amplifies the electric signal ES1 that has been obtained by the PD 323. The electric signal ES1 that has been amplified by the amplifier 324 is supplied to the second external device (not illustrated).

The laser light L2 that has been obtained by the mode splitter 322 is supplied to the modulator 325 via the optical fiber 327. The driver 326 drives the modulator 325 in accordance with an electric signal MS2 that has been obtained from the second external device (not illustrated). The modulator 325 generates the signal light S2 by modulating, in accordance with the electric signal MS2, the laser light L2 that has been obtained by the mode splitter 322. The signal light S2 that has been generated by the modulator 325 is transmitted to the optical module 311 via the optical fiber 333.

The AOC 301 thus configured makes it possible to employ, as a method by which to multiplex the signal light (S1) and the laser light (L2), a spatial mode multiplexing method instead of a wavelength multiplexing method and a polarization multiplexing method.

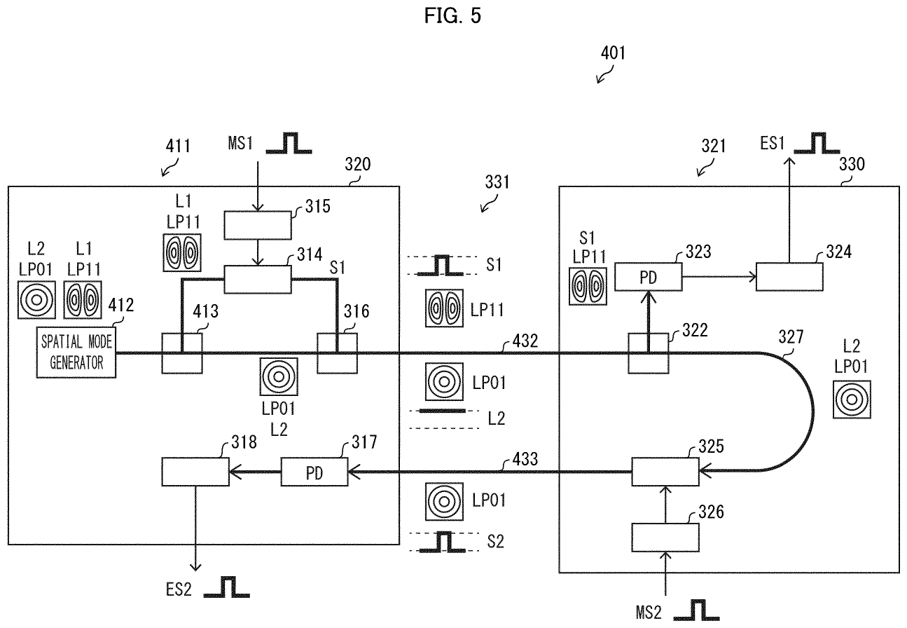

Subsequently, the AOC 301 in accordance with one or more embodiments is described below. FIG. 5 is a block diagram illustrating a configuration of an AOC 401 in accordance with one or more embodiments.

The AOC 401 and the AOC 301 differ in (1) that the spatial mode generator 313 is omitted in the AOC 401, (2) that a spatial mode generator 412 that generates laser light including both laser light in an LP 11 mode (laser light L1, which is a first laser) and laser light in an LP 01 mode (laser light L2, which is second laser light) is used, in the AOC 401, instead of the spatial mode generator 312 that generates the laser light L1 in the LP 11 mode, and (3) that the AOC 401 further includes a mode splitter 413 that separates, into the laser light L1 in the LP 11 mode and the laser light L2 in the LP 01 mode, the laser light that has been generated by the spatial mode generator 412. Of the laser light that has been branched by the mode splitter 413, the laser light L1 in the LP 11 mode is supplied to a modulator 314, and the laser light L2 in the LP 01 mode is supplied to a mode combiner 316. According to one or more embodiments, the spatial mode generator 412 generates the laser light including the first laser light L1 and the second laser light L2. That is, the spatial mode generator 412 has both a function of a first light emitting element and a function of a second light emitting element. Note here that in one or more embodiments, the first laser light L1 and the second laser light L2 that are included in the laser light generated by the spatial mode generator 412 are beams of laser light which beams are identical in characteristic (e.g., wavelength). That is, the spatial mode generator 412 generates the laser light in a form of a single beam of laser light in which single beam the first laser light L1 and the second laser light L2 are combined. Then, the single beam of laser light is branched into the first laser light L1 and the second laser light L2 while being propagated through the mode splitter 413 (see FIG. 5).

As compared with the AOC 301, the AOC 401, which allows a light emitting element of a first optical module 411 to be a single light emitting element, makes it possible to achieve the AOC 401 in which the first optical module 411 includes fewer light emitting elements.

Note that the AOC 401 in accordance with one or more embodiments can also be configured in a form of an optical integrated circuit obtained by integrating, on a single substrate, sections of the first optical module 411 and sections of the first optical module 411. Consequently, the AOC 401 allows the first optical module 411 to have a smaller size. Furthermore, the configuration makes it possible to achieve the AOC 401 that can be manufactured at lower cost.

Finally, a configuration of an AOC in accordance with one or more embodiments of the present invention is described below.

(Configuration of AOC 501)

First, a configuration of the AOC 501 in accordance with one or more embodiments of the present invention is described below with reference to FIG. 6. FIG. 6 is a block diagram illustrating the configuration of the AOC 501.

As illustrated in FIG. 6, the AOC 501 is an AOC that allows bidirectional communication and includes an optical module 511, which is a first optical module, an optical module 521, which is a second optical module, and a cable 531. The cable 531 includes optical fibers 532, 533, and 534, which are a plurality of optical fibers. One or more embodiments employ a single mode fiber as each of the optical fibers 532, 533, and 534. The optical module 511 and the optical module 521 are optically coupled via the optical fibers 532, 533, and 534.

The optical module 511 that is connectable to a first external device (not illustrated) includes an LD 512, which is a first light emitting element, an LD 513, which is a second light emitting element, a modulator 514, which is a first modulator, a driver 515, a PD 517, an amplifier 518, and a connector 520. The connector 520, which is a housing that houses the optical module 511, includes the LD 512, the LD 513, the modulator 514, the driver 515, the PD 517, and the amplifier 518.

The LD 512 and the LD 513 emit respective beams of laser light (continuously oscillating light). Laser light L1 that is emitted by the LD 512 and laser light L2 that is emitted by the LD 513 can have respective wavelengths that are identical to or different from each other. The laser light L2 that has been emitted by the LD 513 is transmitted to the optical module 521 via the optical fiber 533.

The laser light L1 that has been emitted by the LD 512 is supplied to the modulator 514. The driver 515 drives the modulator 514 in accordance with an electric signal MS1 that has been obtained from the first external device (not illustrated). The modulator 514 generates signal light S1 by modulating, in accordance with the electric signal MS1, the laser light L1 that has been emitted by the LD 512. The signal light S1 that has been generated by the modulator 514 is transmitted to the optical module 521 via the optical fiber 532.

The PD 517 converts, into an electric signal ES2, signal light S2 that has been received from the optical module 521 via the optical fiber 534. The electric signal ES2 that has been obtained by the PD 517 is supplied to the amplifier 518. The amplifier 518, which is constituted by, for example, a transimpedance amplifier and a limiting amplifier, amplifies the electric signal ES2 that has been obtained by the PD 517. The electric signal ES2 that has been amplified by the amplifier 518 is supplied to the first external device (not illustrated).

In contrast, the optical module 521 that is connectable to a second external device (not illustrated) includes a PD 523, an amplifier 524, a modulator 525, which is a second modulator, a driver 526, and a connector 530. The connector 530, which is a housing that houses the optical module 521, includes the PD 523, the amplifier 524, the modulator 525, which is the second modulator, and the driver 526.

The signal light S1 that has been received from the optical module 511 via the optical fiber 532 is supplied to the PD 523. The PD 523 converts the signal light S1 into an electric signal ES1. The electric signal ES1 that has been obtained by the PD 523 is supplied to the amplifier 524. The amplifier 524, which is constituted by, for example, a transimpedance amplifier and a limiting amplifier, amplifies the electric signal ES1 that has been obtained by the PD 523. The electric signal ES1 that has been amplified by the amplifier 524 is supplied to the second external device (not illustrated).

In contrast, the laser light L2 that has been received from the optical module 511 via the optical fiber 533 is supplied to the modulator 525. The driver 526 drives the modulator 525 in accordance with an electric signal MS2 that has been obtained from the second external device (not illustrated). The modulator 525 generates the signal light S2 by modulating, in accordance with the electric signal MS2, the laser light L2 received. The signal light S2 that has been generated by the modulator 525 is transmitted to the optical module 511 via the optical fiber 534.

As described earlier, also according to the AOC 501, the LD 513 that emits the second laser light L2 is included not in the second optical module 521 but in the first optical module 511. Thus, according to the AOC 501, it is unnecessary to supply, to the second optical module 521, electric power by which to generate the second laser light L2. This makes it possible to achieve stable bidirectional communication also in a case where electric power that is insufficient to generate the second laser light L2 is supplied from the second external device. Furthermore, it is unnecessary to provide the second optical module 521 with a space in which to provide (i) a light source for emitting the second laser light L2 and (ii) a heat dissipating component for dissipating heat that is generated during generation of the second laser light L2. Consequently, the AOC 501 allows the second optical module 521 to have a smaller size.

(Recap)

One or more embodiments of the present invention can also be expressed as follows:

An active optical cable (1, 101, 201, 301, 401, 501) in accordance with one or more embodiments of the present invention is an active optical cable (1, 101, 201, 301, 401, 501) that allows bidirectional communication, including: a plurality of optical fibers (27, 32, 33, 127, 132, 133, 327, 332, 333, 532, 533, 534); and a first optical module (11, 111, 211, 311, 411, 511) and a second optical module (21, 121, 221, 321, 421, 521) that are coupled via the plurality of optical fibers (27, 32, 33, 127, 132, 133, 327, 332, 333, 532, 533, 534). According to the present active optical cable (1, 101, 201, 301, 401, 501), the first optical module (11, 111, 211, 311, 411, 511) includes (i) at least one light emitting element (12, 112, 212, 312, 412, 512) that emits laser light and (ii) a first modulator (14, 114, 214, 314, 514) that modulates first laser light (L1) so as to convert the first laser light (L1) into first signal light (S1), the first laser light (L1) being included in the laser light, and the second optical module (21, 121, 221, 321, 421, 521) includes a second modulator (25, 125, 325, 525) that modulates second laser light (L2, L2B) so as to convert the second laser light (L2, L2B) into second signal light (S2), the second laser light (L2, L2B) being included in (a) the laser light or (b) laser light that is emitted by a light emitting element (13, 113, 212, 313, 412, 513) that is different from the at least one light emitting element (12, 112, 212, 312, 412, 512) and is included in the first optical module (11, 111, 211, 311, 411, 511).

With the configuration, at least one of light emitting elements that emit the second laser light is included not in the second optical module but in the first optical module. This allows the present active optical cable to supply, via the first optical module to at least one light emitting element of the light emitting elements that emit the second laser light, electric power by which to drive the at least one light emitting element. The present active optical module thus allows lower electric power to be supplied from the second optical module to the light emitting elements that emit the second laser light.

This allows the present active optical cable to achieve an AOC that allows stable bidirectional communication also in a case where electric power that is insufficient to drive a light emitting element is supplied from one of two devices to which an active optical cable is connected.

The active optical cable (1, 101, 201, 301, 401, 501) in accordance with one or more embodiments of the present invention may be configured such that the at least one light emitting element (13, 113, 212, 313, 412, 513) that emits the second laser light (L2, L2B) is not included in the second optical module (21, 121, 221, 321, 421, 521).

The configuration allows electric power by which to drive the at least one light emitting element that emits the second laser light to be supplied to the at least one light emitting element only via the first optical module. This allows the present active optical cable to achieve an AOC that allows more stable bidirectional communication also in a case where electric power that is insufficient to drive a light emitting element is supplied from one of two devices to which an active optical cable is connected.

The active optical cable (1, 101, 201, 301, 401) in accordance with one or more embodiments of the present invention may be configured such that: the first optical module (11, 111, 211, 311, 411) further includes a multiplexer (16, 116, 316) that multiplexes the first signal light (S1) and the second laser light (L2, L2B); and the second optical module (21, 121, 221, 321, 421) further includes a demultiplexer (22, 122, 322) that demultiplexes the first signal light (S1) and the second laser light (L2, L2B) that have been multiplexed.

As compared with an active optical cable that includes no multiplexer and no demultiplexer, the configuration makes it possible to achieve an active optical cable in which the first optical module and the second optical module are coupled via fewer optical fibers.

The active optical cable (1) in accordance with one or more embodiments of the present invention may be configured such that: the at least one light emitting element (12, 13) comprises (i) a first light emitting element (12) that emits the first laser light (L1) that has a first wavelength and (ii) a second light emitting element (13) that emits the second laser light (L2) that has a second wavelength; the multiplexer (16) is a wavelength multiplexer that wavelength-multiplexes the first signal light (S1) and the second laser light (L2) in accordance with a wavelength; and the demultiplexer (22) is a wavelength multiplexer that wavelength-demultiplexes the first signal light (S1) and the second laser light (L2) in accordance with a wavelength.

With the configuration, a wavelength multiplexing method can be employed as a method by which to multiplex the first signal light and the second laser light.

The active optical cable (101, 201) in accordance with one or more embodiments of the present invention may be configured such that: the at least one light emitting element (112, 113, 212) emits the first laser light (L1) and the second laser light (L2A) that are polarized in respective identical directions; the first optical module (111, 211) further includes a polarization rotator (119) that causes the second laser light (L2A) and the first laser light (L1) to be polarized in respective different directions; the multiplexer (116) is a polarization beam combiner (polarization multiplexer) that multiplexes the first signal light (S1) and the second laser light (L2B) that are polarized in respective different directions; and the demultiplexer (122) is a beam splitter (polarization multiplexer) that demultiplexes the first signal light (S1) and the second laser light (L2B) that are polarized in the respective different directions.

With the configuration, a polarization multiplexing method can be employed as a method by which to multiplex the first signal light and the second laser light. Furthermore, since one or more embodiments of the present invention can be carried out by applying, to an AOC, an optical fiber that is already commercially available, such as a polarization maintaining fiber (e.g., a PANDA fiber), it is possible to achieve an AOC that allows one or more embodiments of the present invention to be relatively easily carried out.

The active optical cable (301, 401) in accordance with one or more embodiments of the present invention may be configured such that: the at least one light emitting element (312, 313, 412) comprises (i) a first light emitting element (312, 412) that emits the first laser light (L1) in which electromagnetic waves are spatially distributed in a first mode and (ii) a second light emitting element (313, 412) that emits the second laser light (L2) in which electromagnetic waves are spatially distributed in a second mode; the multiplexer (316) is a mode combiner that multiplexes respective spatial modes of the first laser light (L1) and the second laser light (L2); and the demultiplexer (322) is a mode splitter that demultiplexes the respective spatial modes of the first laser light (L1) and the second laser light (L2).

With the configuration, a spatial mode multiplexing method can be employed as a method by which to multiplex the first signal light and the second laser light.

The active optical cable (1, 101, 201, 301, 401) in accordance with one or more embodiments of the present invention may be configured such that: the at least one light emitting element (212, 412) is a single light emitting element (212, 412); and the first optical module (11, 111, 211, 311, 411) further includes a branching element (213, 413) that branches, into the first laser light (L1) and the second laser light (L2), laser light that has been emitted by the single light emitting element (212, 412).

The configuration allows the first optical module to include fewer light emitting elements.

The first optical module (11, 111, 211, 311, 411) of the active optical cable (1, 101, 201, 301, 401) in accordance with one or more embodiments of the present invention may be configured such that at least one of (1) the first modulator (14, 114, 214, 314) and the multiplexer (16, 116, 316) and (2) the demultiplexer (22, 122, 322) and the second modulator (25, 125, 325) are configured in a form of an optical integrated circuit by being integrated on a single SOI substrate.

The configuration allows at least one of (i) the first optical module including the first modulator and the multiplexer and (ii) the second optical module including the demultiplexer and the second modulator to have a smaller size. Furthermore, the configuration makes it possible to achieve an active optical cable that can be manufactured at lower cost.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1, 101, 201, 301, 401, 501 Active optical cable
11, 111, 211, 311, 411, 511 Optical module (first optical module)
12, 112 LD (first light emitting element)
13, 113 LD (second light emitting element)
212 LD (serving as both first light emitting element and second light emitting element)
312 Spatial mode generator (first light emitting element)
313 Spatial mode generator (second light emitting element)
412 Spatial mode generator (serving as both first light emitting element and second light emitting element)
14, 114, 214, 314, 514 Modulator (first modulator)
15, 115, 315, 515 Driver
16 Dichroic mirror (wavelength multiplexer, multiplexer)
116 Polarization beam combiner (multiplexer)
316 Mode combiner (multiplexer)
17, 117, 317, 517 PD (light receiving element)
18, 118, 318, 518 Amplifier
20, 120, 320, 520 Connector
21, 121, 221, 321, 421, 521 Optical module (second optical module)
22 Dichroic mirror (wavelength demultiplexer, demultiplexer)
122 Polarization beam splitter (demultiplexer)
322 Mode splitter (demultiplexer)
23, 123, 323, 523 PD (light receiving element)
24, 124, 324, 524 Amplifier
25, 125, 325, 525 Modulator (second modulator)
26, 126, 326, 526 Driver
30, 130, 330, 530 Connector
31, 131, 331, 531 Cable
27, 32, 33, 127, 132, 133, 327, 332, 333, 532, 533, 534 Optical fiber
119 Polarization rotator
213 Branching element
413 Mode splitter (branching element)

1. An active optical cable that allows bidirectional communication comprising:
a plurality of optical fibers; and
a first optical module and a second optical module that are coupled via the plurality of optical fibers, wherein
the first optical module comprises:
at least one first light emitting element that emits laser light and a second light emitting element that also emits laser light; and
a first modulator that modulates first laser light and converts the first laser light into first signal light, wherein
the first laser light is part of the laser light emitted by the at least one first light emitting element, and
the second optical module comprises a second modulator that modulates second laser light and converts the second laser light into second signal light, wherein
the second laser light is either part of the laser light emitted by the at least one first light emitting element or part of the laser light emitted by the second light emitting element.

2. The active optical cable according to claim 1, wherein the second optical module lacks any first light emitting element that emits the second laser light.

3. The active optical cable according to claim 1, wherein
the first optical module further comprises a multiplexer that multiplexes the first signal light and the second laser light; and
the second optical module further comprises a demultiplexer that demultiplexes the first signal light and the second laser light that have been multiplexed.

4. The active optical cable according to claim 3, wherein
one first light emitting element emits the first laser light that has a first wavelength, and
another first light emitting element emits the second laser light that has a second wavelength;
the multiplexer is a wavelength multiplexer that wavelength-multiplexes the first signal light and the second laser light in accordance with a wavelength; and
the demultiplexer is a wavelength demultiplexer that wavelength-demultiplexes the first signal light and the second laser light in accordance with a wavelength.

5. The active optical cable according to claim 3, wherein
the at least one first light emitting element emits the first laser light and the second laser light that are polarized in respective identical directions;
the first optical module further comprises a polarization rotator that causes the second laser light and the first laser light to be polarized in respective different directions;
the multiplexer is a polarization beam combiner that multiplexes the first signal light and the second laser light that are polarized in respective different directions; and
the demultiplexer is a polarization beam splitter that demultiplexes the first signal light and the second laser light that are polarized in the respective different directions.

6. The active optical cable according to claim 3, wherein
one first light emitting element emits the first laser light in which electromagnetic waves are spatially distributed in a first mode, and
another first light emitting element emits the second laser light in which electromagnetic waves are spatially distributed in a second mode;
the multiplexer is a mode combiner that multiplexes respective spatial modes of the first laser light and the second laser light; and
the demultiplexer is a mode splitter that demultiplexes the respective spatial modes of the first laser light and the second laser light.

7. The active optical cable according to claim 3, wherein
the first optical module comprises no more than one first light emitting element, and
the first optical module further comprises a branching element that branches the laser light emitted by the one first light emitting element into the first laser light and the second laser light.

8. The active optical cable according to claim 3, wherein an optical integrated circuit on a single SOI substrate comprises at least one of (1) the first modulator and the multiplexer and (2) the demultiplexer and the second modulator.
